(19) United States
(12) Patent Application Publication
(10) Pub. No.: US 2022/0015881 A1
(43) Pub. Date: Jan. 20, 2022

(54) TOOTHPICK STRUCTURE

(71) Applicant: JON-CHEN LEE, CHIAYI COUNTY (TW)

(72) Inventor: JON-CHEN LEE, CHIAYI COUNTY (TW)

(21) Appl. No.: 17/111,776

(22) Filed: Dec. 4, 2020

(30) Foreign Application Priority Data
Jul. 15, 2020 (TW) 109209008

(51) Int. Cl. A61C 15/02

(52) U.S. Cl. CPC A61C 15/02

(57) ABSTRACT

The present invention discloses a toothpick structure which has a main body and at least one flake-shaped picking part connected to at least one terminal of the main body. The picking part further comprises two corresponding jagged laterals.

### BACKGROUND OF THE INVENTION

### 1. Field of the Invention

The present invention relates to a toothpick structure having at least one flake-shaped picking part for removal of food debris from tooth gaps, so as to prevent expansion of the tooth gaps and gum injuries.

### 2. Description of Related Art

A toothpick is usually used in daily life. After dinning, the toothpick is used to remove food debris in a tooth gap for preventing the food debris left on the teeth so as to prevent odor generation in the mouth due to fermentation and decaying of the food debris.

A conventional toothpick comprises a round stick-shaped main body and at least one coned picking part having a sharping angle connected to at least one terminal of the main body. When cleaning the teeth, the coned picking part is inserted in to a tooth gap to pick up the food debris therein. However, the coned picking part is too sharp and may punch into the gum of a user which causes bleeding of the gum when using carelessly. In addition, the tooth gaps of the user are easily expanded when the coned picking part is deeply inserted into the tooth gaps due to a diameter of the conventional toothpick gradually increasing from the coned picking part to the main body thereof. The tooth gaps of the user are then enlarged and the food debris is pushed deeply into the tooth gaps. In such a case, it will be difficult to clean teeth thoroughly and that is why the conventional toothpick needs to be improved.

### SUMMARY OF THE INVENTION

The present invention relates to a toothpick structure having at least one flake-shaped picking part to remove food debris left in a gap between two teeth, so as to prevent expansion of tooth gaps and gum injuries.

The toothpick structure of the present invention comprises a main body and at least one flake-shaped picking part connected to at least one terminal of the main body, wherein the at least one flake-shaped picking parts has a first end connected to the main body and a second end opposite to the first end.

In the toothpick structure mentioned above, the at least one flake-shaped picking part is gradually tapered from the first end to the second end thereof.

In the toothpick structure mentioned above, the at least one flake-shaped picking part has two corresponding jagged laterals.

In the toothpick structure mentioned above, the at least one flake-shaped picking part is provided with a semi-circular tip at the second end thereof.

In the toothpick structure mentioned above, the main body is a rectangular rod.

In the toothpick structure mentioned above, the at least one flake-shaped picking part has a thickness ranging from 0.1 mm to 0.3 mm.

In the toothpick structure mentioned above, the main body has two opposite terminals to which the first ends of a first flake-shaped picking part and a second flake-shaped picking part are connected respectively.

In the toothpick structure mentioned above, the first flake-shaped picking part is gradually tapered from the first end thereof to the second end thereof.

In the toothpick structure mentioned above, the second flake-shaped picking part has two corresponding jagged laterals thereof.

In the toothpick structure mentioned above, each of the first and second flake-shaped picking parts has a semi-circular tip at the second end thereof.

Accordingly, when using the preset invention to remove the food debris in tooth gaps, the flake-shaped picking part is inserted into the tooth gaps easily due to its specific shape design and the tooth gaps won't be expanded. In addition, the corresponding jagged laterals of the flake-shaped picking part can be served to pull and remove food debris inside tooth gaps more easily. Therefore, the toothpick structure of the present invention enables to remove food debris from teeth in a manner of much more convenience, safety and efficiency without undesired expansion of tooth gaps and gum injuries.

### BRIEF DESCRIPTION OF THE DRAWINGS

FIG. 1 is a stereogram showing a toothpick structure of the present invention;

FIG. 2 is a front view showing a toothpick structure of the present invention in assembly;

FIG. 3 is a side view showing a toothpick structure of the present invention in assembly;

FIG. 4 is a partial enlarged front view showing a toothpick structure of the present invention.

### DETAILED DESCRIPTION OF THE PREFERRED EMBODIMENT

To provide a thorough understanding, the purpose and advantages of the present invention will be described in detail with reference to the accompanying drawings.

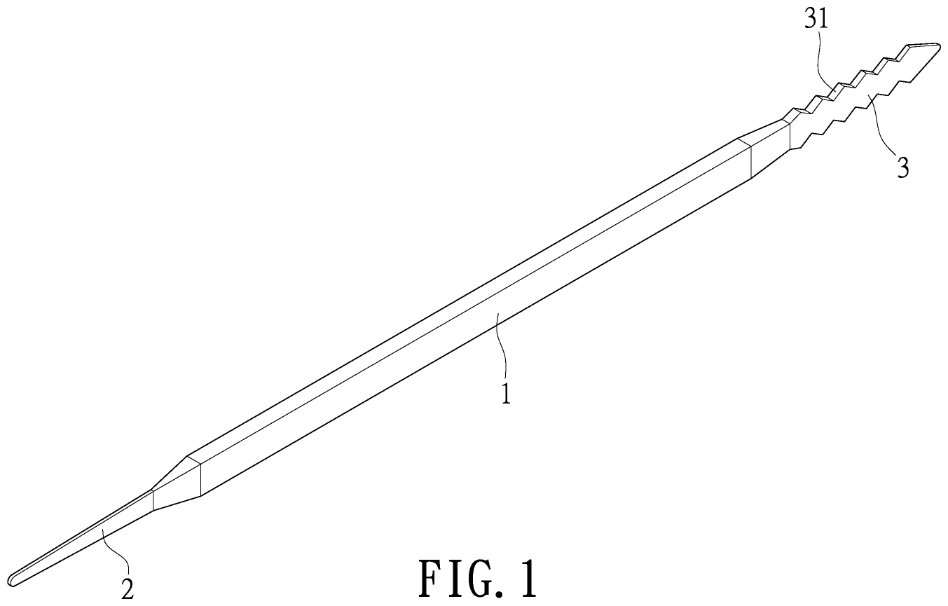

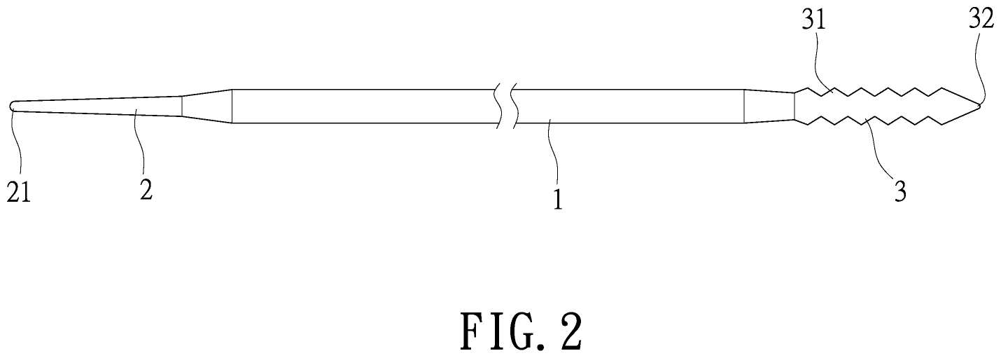

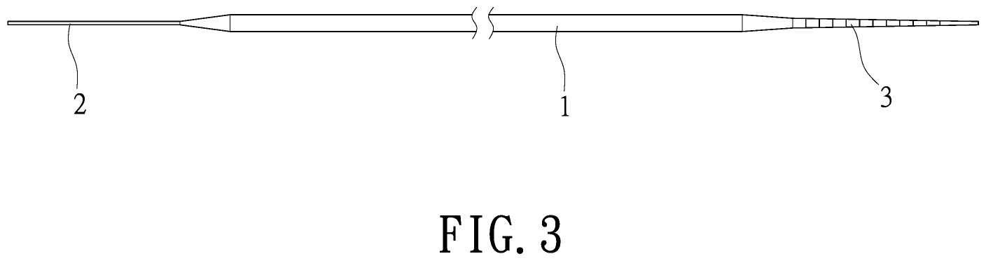

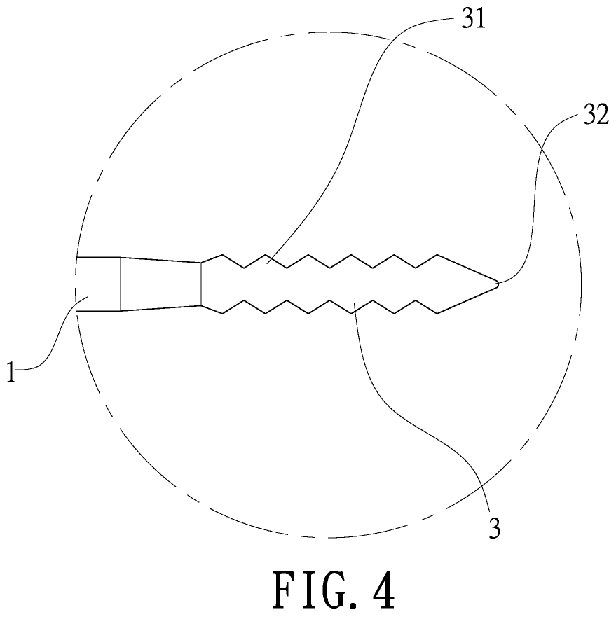

Please referring to FIG. 1 to FIG. 3, a toothpick structure of the present invention comprises a main body (1), a first picking part (2) and a second picking part (3). The main body (1) is a rectangular rod and has two opposite terminals connected to the first picking part (2) and the second picking part (3) respectively. Each of the first picking part (2) and the second picking part (3) is has a first end connected to the main body (1) and a second end opposite to the first end. In addition, each of the first picking part (2) and the second picking part (3) is shaped as a flake and has a thickness ranging from 0.1 mm to 0.3 mm The first picking part (2) is connected to the terminal of the main body by the first end gradually tapered from the first end thereof to the second end thereof. The second picking part (3) has two corresponding jagged laterals (31). Furthermore, each of the first picking part (2) and the second picking part (3) has a semi-circular tip (21) (32) at the second end thereof as shown in FIG. 4.

When using the present invention to clean teeth of a user, the first picking part (2) is used first to clean tooth gaps of the user. The first picking part (2) is easily inserted into the tooth gaps due to its specific flake-shaped design to remove food debris from the tooth gaps. Besides, the flake-shaped first picking part (2) will not expand the tooth gaps when inserting into the tooth gaps. In addition, the first picking part (2) can move back and forth and reach into a deep region in the tooth gaps for removal the food debris attached in the tooth gaps efficiently.

If the food debris in the tooth gaps is not removed completely after cleaning by the first picking part (2), the second picking part (3) is then used to clean the tooth gaps. The second picking part (3) can also insert into the tooth gaps easily due to its flake shape. When the user moves the second picking part (3) back and forth in the tooth gaps, the two jagged laterals (31) of the third picking part (3) can be served to pull and remove the food debris inside the tooth gaps completely. In addition, the present invention can be used as a fork for eating fruits. The third picking part (3) can fork fruits stably due to a great holding ability of the two jagged laterals (31) thereof. So the present invention prevents the fruits from falling off and increases the convenience of eating fruits.

Furthermore, each of the first picking part (2) and the second picking part (3) has a semi-circular tip (21) (32) at the second end thereof, which prevents gum injuries of the user when cleaning teeth. So the present invention improves the disadvantages of a conventional toothpick having a sharp coned picking part which may punch into the gum of a user and cause bleeding of the gum when using carelessly. Therefore, the toothpick structure of the present invention can remove food debris from teeth in a manner of much more convenience, safety and efficiency without undesired expansion of tooth gaps and gum injuries.

The abovementioned embodiment and figures are not limited to the scopes of the present invention. In a second embodiment of the present invention, the main body (1) connected to only one flake-shaped picking part at one terminal. So a toothpick structure having only one flake-shaped picking part connected to one terminal of a main body is also fallen in the scope of the present invention.

According to the above description, the present invention has advantages as:

1. The toothpick structure of the present invention has at least one flake-shaped picking part which can insert into tooth gaps easily for removal food debris without expansion of the tooth gaps.

2. The picking part of the present invention has two corresponding jagged laterals which can be served to pull and remove the food debris inside tooth gaps completely.

3. The two jagged laterals of the picking part of the present invention has great holding ability for forking fruits stably when eating fruits so as to increase the convenience of eating fruits.

4. The picking part of the present invention has a semi-circular tip which is safe to use. Therefore, a safety problem of the conventional toothpick having a sharp end at the picking part which is easily punched into the gum of a user is improved.

What is claimed is:

1. A toothpick structure, comprising
a main body; and
at least one picking part shaped as a flake, having a first end connected to at least one terminal of the main body and a second end opposite to the first end.

2. The toothpick structure as claimed in claim 1, wherein the at least one picking part is gradually tapered from the first end thereof to the second end thereof.

3. The toothpick structure as claimed in claim 1, wherein the at least one picking part further has two corresponding jagged laterals thereof.

4. The toothpick structure as claimed in claim 1, wherein the at least one picking part is provided with a semi-circular tip at the second end thereof.

5. The toothpick structure as claimed in claim 1, wherein the main body is a rectangular rod.

6. The toothpick structure as claimed in claim 1, wherein the at least one picking part has a thickness ranging from 0.1 mm to 0.3 mm

7. The toothpick structure as claimed in claim 1, wherein the main body has two opposite terminals connected to the first ends of first and second picking parts, respectively.

8. The toothpick structure as claimed in claim 7, wherein the first picking part is gradually tapered from the first end thereof to the second end thereof.

9. The toothpick structure as claimed in claim 7, wherein the second picking part has two corresponding jagged laterals thereof.

10. The toothpick structure as claimed in claim 7, each of the first and second picking parts has a semi-circular tip at the second end thereof.
